(19) United States
(12) Patent Application Publication
(10) Pub. No.: US 2009/0157833 A1
(43) Pub. Date: Jun. 18, 2009

(54) SYSTEM AND METHOD FOR SENDING EMAILS

(75) Inventors: CHUNG-I LEE, Tu-Cheng (TW); XIN-YU HUANG, Shenzhen City (CN); WEN-HAO WU, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/325,276

(22) Filed: Dec. 1, 2008

(30) Foreign Application Priority Data
Dec. 14, 2007 (CN) 200710203101.9

(51) Int. Cl. G06F 15/16; G06F 17/30

(52) U.S. Cl. 709/206; 707/3; 707/E17.014

(57) ABSTRACT

A method for sending email is provided. The method receives an email to be sent from a sender computer that is connected to an application server, sends a search instruction to email communication servers for obtaining a total number of emails to be sent in each of the email communication servers. The method further selects an email communication server which has the least total number of the emails, sends the obtained email to be sent to the selected email communication server, and receives a result generated by the selected email communication server.

### BACKGROUND

1. Field of the Invention

Embodiments of the present disclosure relate to email management systems and methods, and more particularly to a system and method for sending emails.

2. Description of Related Art

During the past decade, electronic mail (“e-mail”) has become an indispensable tool for facilitating business and personal communications. Through computer networking systems such as local-area networks (LAN), wide-area networks (WAN), and the world-wide-web (WWW), network users can send and receive notes, messages, and letters to communicate with others who are in the same office or perhaps in other locations across the world.

Some email facilitators have many email communication servers. As the number of users increases, the number of email communication servers may not keep up with the demand. Some email communication servers have too many users and other email communication servers lack users, which leads to imbalance of email communication servers for sending email.

Therefore, an effective system and method for sending emails is desired to overcome the above-described shortcomings.

### BRIEF DESCRIPTION OF THE DRAWINGS

FIG. 1 is a block diagram of one embodiment of a system for sending emails;

FIG. 2 is a block diagram of one embodiment of an email monitor of the email management unit 21 of FIG. 1; and

FIG. 3 is a flowchart of one embodiment of a method for sending emails;

### DETAILED DESCRIPTION OF CERTAIN INVENTIVE EMBODIMENTS

All of the processes described below may be embodied in, and fully automated via, functional modules executed by one or more general purpose processors. The functional modules may be stored in any type of computer-readable medium or other computer storage device.

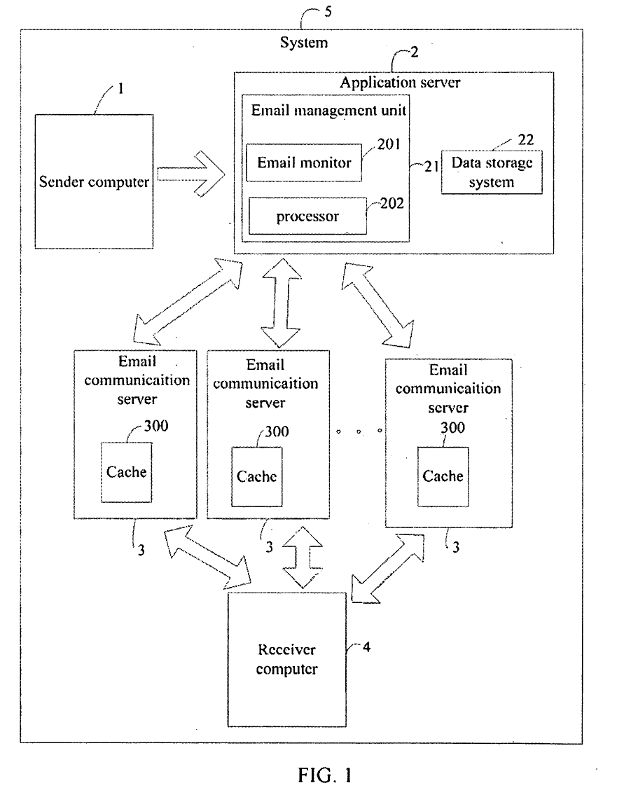

FIG. 1 is a block diagram of one embodiment of a system 5 for sending emails (hereinafter, “the system 5”). In one embodiment, the system 5 includes a sender computer 1, an application server 2, a plurality of email communication servers 3, and a receiver computer 4. The sender computer 1 is connected to the application server 2 through a network, and is used to send emails to the application server 2 via the network. The email communication servers 3 are connected to the application server 2 via a local-area network (LAN), and are connected to the receiver computer 4 through the Internet.

In one embodiment, the application server 2 includes an email management unit 21, and a data storage system 22. The email management unit 21 includes an email monitor 201, and at least one processor 202. In one embodiment, the email monitor 201 may be an ActiveX control and is executed by the at least one processor 202. The data storage system 22 may be an email collector that collects information of the emails to be sent from the computer 1. The information of the emails includes the addresses of senders of the email, the address of recipients of the emails, and contents of the emails.

The email communication servers 3 are configured for sending the emails to the receiver computer 4. Each of the email communication servers 3 includes at least one cache 300 for storing the emails to be sent to the receiver computer 4.

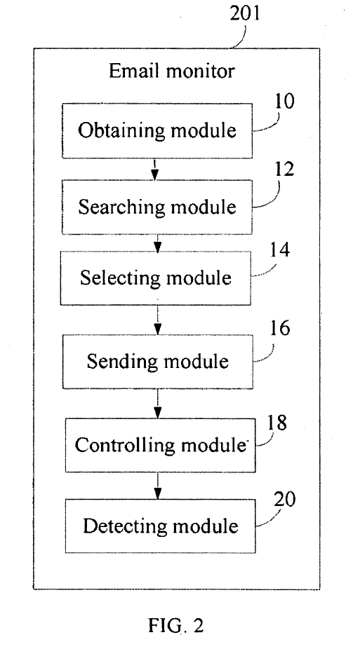

FIG. 2 is a block diagram of the email monitor 201 of the email management unit 21 of the application server 2 of FIG. 1. In one embodiment, the email monitor 201 may include an obtaining module 10, a searching module 12, a selecting module 14, a sending module 16, a controlling module 18, and a deleting module 20. It may be understood that one or more specialized or general purpose processors, such as the processor 202 may be used to execute the function modules 10, 12, 14, 16, 18 and 20. These function modules may be used to perform certain functions for sending emails to be sent from the sender computer 1 to the receiver computer 4.

The obtaining module 10 is configured for receiving an email to be sent from the sender computer 1, and for storing information of the email into the data storage system 22 of the application server 2. In one embodiment, the information of the received email includes the address of a sender of the email, the address of a recipient of the email, and a content of the email.

The searching module 12 is configured for generating a search instruction for obtaining a total number of the emails stored in the cache 300 of each of the email communication servers 3. Each of the email communication servers 3 sends the total number of the emails of the cache 300 to the email monitor 201 of the application server 2. Additionally, if there is no response from one of the email communication servers 3, the searching module 12 reports that the one of the email communication servers 3 is in fault.

The selecting module 14 is configured for selecting one of the email communication servers 3 which has the least total number of emails in the cache 300 of the email communication server 3.

The sending module 16 is configured for obtaining the email from the data storage system 22, and sending the email to the selected email communication server 3. The selected email communication server 3 stores the email into the cache 300. After sending the email to a receiver computer 4 according to the address of the recipient, the selected email communication server 3 generates and sends a result for indicating if the email has been sent successfully to the email monitor 201 of the application server 2.

The controlling module 18 is configured for generating a sending command for controlling the selected email communication server 3 to send the email to the receiver computer 4, and for receiving the result from the selected email communication server 3.

The detecting module 20 is configured for detecting the result to determine if the email has been sent successfully, and deleting the information of the email from the data storage system 22 if the email has been sent successfully.

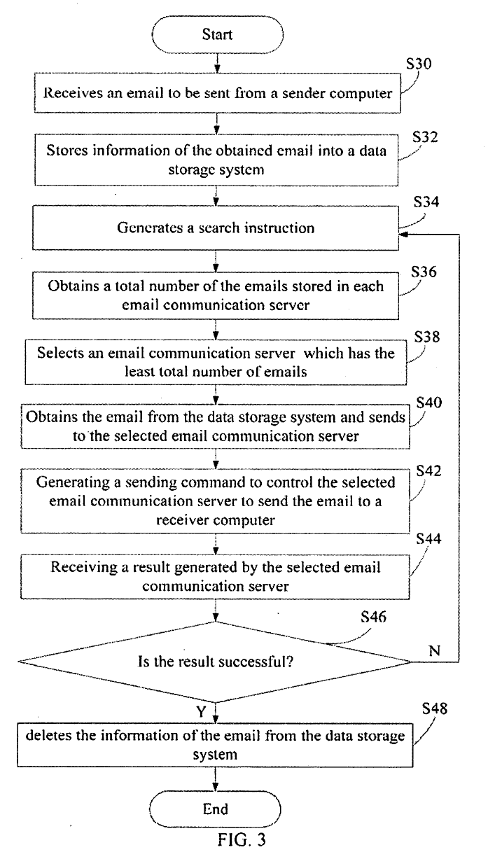

FIG. 3 is a flowchart of one embodiment of a method for sending emails. Depending on the embodiment, additional blocks may be added, others removed, and the ordering of the blocks may be changed.

In block S30, the obtaining module 10 receives an email to be sent from the sender computer 1 to the receiver computer 4.

In block S32, the obtaining module 10 stores information of the received email into the data storage system 22 of the application server 2. In the embodiment, the information of the received email includes the address of a sender and a recipient of the email, and a content of the email.

In block S34, the searching module 12 generates a search instruction for obtaining a total number of the emails stored in the cache 300 of each of email communication servers 3.

In block S36, the searching module 12 obtains the total number of the emails stored in the cache 300 of each of the email communication servers 3 according to the search instruction.

In block S38, the selecting module 14 selects an email communication server 3 from the plurality of email communication severs 3. The selected email communication server 3 has the least total number of emails in the cache 300.

In block S40, the sending module 16 obtains the email from the data storage system 22, and sends the email to the selected email communication server 3.

In block S42, the controlling module 18 generates a sending command to control the selected email communication server 3 to send the email to the receiver computer 4 according to the recipient address of the email.

In block S44, the controlling module 18 receives a result indicating if the emails have been sent successfully generated by the selected email communication server 3.

In block S46, the detecting module 20 detects the result to determine if the email has been sent successfully. If the email has been sent unsuccessfully, the process returns to the block S34.

Otherwise, if the email has been sent successfully, in block S48, the detecting module 20 deletes the information of the email from the data storage system 22 of the application server 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An application server for sending emails, the server in electronic communication with a plurality of email communication servers, the application server comprising:
an obtaining module configured for receiving an email to be sent from a sender computer, and for storing information of the email to a data storage system of the application server;
a searching module configured for generating a search instruction, and for obtaining a total number of emails stored in each of the plurality of email communication servers according to the search instruction;
a selecting module configured for selecting an email communication server from the plurality of email communication servers, the selection according to an email communication server having the least total number of the emails;
a sending module configured for obtaining the email from the data storage system, and sending the email to the selected email communication server; and
a controlling module configured for generating a sending command for controlling the selected email communication server to send the email to a receiver computer.

2. The system of claim 1, wherein the application server further comprises at least one processor for executing the obtaining module, the searching module, the sending module, the selecting module, and the controlling module.

3. The system of claim 1, wherein the controlling module is further configured for receiving a result indicating if the email has been sent successfully generated by the selected email communication server.

4. The system of claim 1, wherein the application server further comprises:
a detecting module configured for detecting the result to determine if the email has been sent successfully, and for deleting the information of the email from the data storage system if the email has been sent successfully.

5. The system of claim 1, wherein the data storage system is an email collector configured for collecting information of the emails to be sent from the sender computer.

6. The system of claim 5, wherein the information of each email comprises a content of the email, an address of a sender, and an address of a recipient.

7. A computer-based method for sending emails, the method comprising:
receiving an email to be sent from a sender computer, the sender computer being connected to a application server, the application server being connected with a plurality of email communication servers;
storing information of the email to a data storage system of the application server;
generating a search instruction, and obtaining a total number of emails stored in each of the plurality of email communication servers according to the search instruction;
selecting an email communication server from the plurality of email communication servers, the selection according to an email communication server having the least total number of the emails;
obtaining the email from the data storage system, and sending the email to the selected email communication server; and
generating a sending command to control the selected email communication server to send the email to a receiver computer.

8. The method of claim 7, further comprising:
receiving a result indicating if the email has been sent successfully generated by the selected email communication server;
detecting the result to determine if the email has been sent successfully; and
deleting the information of the email from the data storage system if the email has been sent successfully.

9. The method of claim 7, wherein the data storage system is an email collector which collects information of the emails to be sent from the sender computer.

10. The method of claim 9, wherein the information of each email comprises a content of the email, an address of a sender, and an address of a receiver.

11. A computer-readable medium having stored therein instructions that, when executed by an application server, causes the application server to perform a method for sending emails, the method comprising:
receiving an email to be sent from a sender computer, the sender computer being connected to a application server, the application server being connected with a plurality of email communication servers;
storing information of the email to a data storage system of the application server;
generating a search instruction, and obtaining a total number of emails stored in each of the plurality of email communication servers according to the search instruction;
selecting an email communication server from the plurality of email communication servers, the selection according to an email communication server having the least total number of the emails;
obtaining the email from the data storage system, and sending the email to the selected email communication server; and
generating a sending command to control the selected email communication server to send the email to a receiver computer.

12. The medium of claim 11, wherein the method further comprises:
receiving a result indicating if the email has been sent successfully generated by the selected email communication server;
detecting the result to determine if the email has been sent successfully; and
deleting the information of the email from the data storage system if the email has been sent successfully.

13. The medium of claim 11, wherein the data storage system is an email collector which collects information of the emails to be sent from the sender computer.

14. The method of claim 13, wherein the information of each email comprises a content of the email, an address of a sender, and an address of a receiver.
